(19) United States
(12) Patent Application Publication
(10) Pub. No.: US 2024/0171919 A1
(43) Pub. Date: May 23, 2024

(54) OPTICAL MICROPHONE

(71) Applicant: AAC ACOUSTIC TECHNOLOGIES (SHENZHEN) CO., LTD., Shenzhen (CN)

(72) Inventor: Yannick Pierre Kervran, HK (FR)

(21) Appl. No.: 17/993,804

(22) Filed: Nov. 23, 2022

(51) Int. Cl. H04R 23/00

(52) U.S. Cl. CPC H04R 23/008; H04R 2201/003

(57) ABSTRACT

Provided is an optical microphone, including a case including an inner cavity and a sound inlet aperture that makes the inner cavity communicate with exterior; a micro-electromechanical module in the inner cavity and including a flexible film and a grating; an optoelectronic module in the rear cavity and including a light source and a light beam detector; and an integrated circuit module in the rear cavity and electrically connected to the micro-electromechanical module and the optoelectronic module. The optoelectronic module and the integrated circuit module are provided on a same chip; a reflective layer is provided at a side of the flexible film facing the light source, and another reflective layer is provided at a side of the grating facing the light source. The microphone has following beneficial effects: connection wires are less and crosstalk noise between wires is reduced, thereby achieving easier package manufacturing and better package miniaturization.

### TECHNICAL FIELD

The present invention relates to the technical field of microphones, especially to an optical microphone.

### BACKGROUND

For a conventional microphone, the microphone works based on a capacitor, wherein the diaphragm vibrates with sound waves, and the voltage changes by changing a distance between base plates of the capacitor, so as to achieve acoustic-electric conversion.

The optical microphone is a new type of microphone. The optical microphone usually includes three modules, i.e., an optoelectronic module, an integrated circuit module, and a micro-electromechanical module. The optoelectronic module can emit light directing to the micro-electromechanical module and can receive light reflected by the micro-electromechanical module. When a sound wave actuates the diaphragm of the micro-electromechanical module, the diaphragm vibrates slightly and changes the intensity and/or the phase of the light reflected to the optoelectronic module. The optoelectronic module converts the intensity and/or the phase of the reflected light into an electrical signal and transmits it to the integrated circuit module, so as to achieve conversion from acoustic signal to optical signal and then to electrical signal.

As consumers have higher and higher requirements on experience, it needs to propose an optical microphone with better integration and miniaturized optical microphone package.

### SUMMARY

The present invention provides an optical microphone, aiming to solve the technical problems existing in the prior art, i.e. a complicated package manufacturing for optical microphone.

An embodiment of the present invention provides an optical microphone, including: a case including an inner cavity and a sound inlet aperture that makes the inner cavity communicate with an exterior; a micro-electromechanical module provided in the inner cavity and including a flexible film and a grating, wherein the flexible film separates, along an incident direction of a sound wave, the inner cavity into a front cavity and a rear cavity, the front cavity covers the sound inlet aperture, and the grating is arranged at a side of the flexible film close to the rear cavity and is spaced from the flexible film; an optoelectronic module provided in the rear cavity and including a light source and a light beam detector; and an integrated circuit module provided in the rear cavity and electrically connected to the micro-electromechanical module and the optoelectronic module. The optoelectronic module and the integrated circuit module are provided on a same chip; a reflective layer is provided at a side of the flexible film facing the light source, and another reflective layer is provided at a side of the grating facing the light source; and a part of light emitted from the light source is diffracted by the grating, and then is directed to the flexible film, and then is reflected by the flexible film to the light beam detector; and another part of the light emitted from the light source is directly reflected by the grating reflective layer to the light beam detector.

As an improvement, the micro-electromechanical module further includes a lens, which is provided at a side of the grating facing the optoelectronic module and is spaced from the grating; when the light emitted from the light source vertically irradiates the lens, the light obliquely irradiates the grating after being refracted by the lens; and when light reflected by the grating or the flexible film obliquely irradiates the lens, the light vertically irradiates the light beam detector after being refracted by the lens.

As an improvement, the flexible film is further provided with a sound inlet hole that makes the front cavity communicate with the rear cavity.

As an improvement, the grating includes a plurality of slits spaced from each other and arranged in parallel.

As an improvement, the grating is formed by a lens, and the lens is provided with at least one diffractive surface.

As an improvement, the optoelectronic module includes a plurality of light beam detectors.

As an improvement, the case is formed by a PCB board.

As an improvement, the flexible film has a shape that is symmetrical about its center.

As an improvement, the integrated circuit module is electrically connected to the flexible film and the grating, respectively.

As an improvement, the micro-electromechanical module further includes a supporting part that supports the flexible film and is fixed to the case; and the grating is arranged at a side of the flexible film facing away from the sound inlet aperture by a space, and the grating is spaced from the flexible film.

### BRIEF DESCRIPTION OF DRAWINGS

In order to better illustrate technical solutions in embodiments of the present invention or in the related art, the accompanying drawings used in the embodiments and in the related art are briefly introduced as follows. It should be noted that the drawings described as follows are merely part of the embodiments of the present invention, and other drawings can also be acquired by those skilled in the art without paying creative efforts.

FIG. 1 is an axonometric view of an optical microphone according to an embodiment of the present invention.

### REFERENCE SIGNS

1—case;
2—micro-electromechanical module;
3—optoelectronic module;
4—integrated circuit module;

### DESCRIPTION OF EMBODIMENTS

The embodiments of the present invention will be described in details in the following description. Examples of the embodiments are shown in the accompanying drawing, in which the same or similar reference numerals indicate the same or similar elements or elements with the same or similar functions. The embodiments described below with reference to the drawings are exemplary, and are merely for illustrating the present invention instead of limiting the present invention.

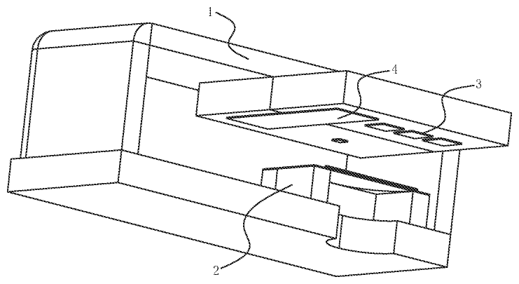

As shown in FIG. 1, an embodiment of the present invention provides an optical microphone, including: a case 1 and a micro-electromechanical module 2. The case 1 includes an inner cavity and a sound inlet aperture that makes the inner cavity communicate with an exterior. In this embodiment, the inner cavity includes a first wall, a second wall, and a side wall which makes the first wall connected to the second wall. The first wall is opposite to the second wall, and the sound inlet aperture is formed at the first wall. It should be noted that the side wall may be integrally formed as a part of the first wall or the second wall, or may be independently formed.

The micro-electromechanical module 2 is provided at the first wall of the inner cavity, and includes a flexible film and a grating. The flexible film separates, along an incident direction of a sound wave X, the inner cavity into a front cavity and a rear cavity. The front cavity covers the sound inlet aperture, and the front cavity is defined by a space between the flexible film and the sound inlet hole. The front cavity is an empty cavity that does not contain any device, so as to achieve better integration and miniaturized optical microphone package, and the rear cavity is defined by a space between the flexible film and an inner volume of the case 1. In this embodiment, the flexible film of the micro-electromechanical module 2 is arranged adjacent to the sound inlet aperture, such that the front cavity has a smaller volume and the rear cavity has a larger volume, thereby further improving the performance.

The grating is arranged at a side of the flexible film close to the rear cavity, and is spaced from the flexible film. The micro-electromechanical module 2 further includes a supporting part that supports the flexible film and is fixed to the case 1. The grating is arranged at a side of the flexible film facing away from the sound inlet aperture, and is spaced from the flexible film by a spacer. In this way, a preset gap is formed between the grating and the flexible film.

An optoelectronic module 3 is provided in the rear cavity, and includes a light source and a light beam detector.

An integrated circuit module 4 is provided in the rear cavity, and is electrically connected to the micro-electromechanical module 2 and the optoelectronic module 3.

The optoelectronic module 3 and the integrated circuit module 4 are provided on a same chip. In an embodiment, a silicon wafer includes the integrated circuit module 4, and a III-V compound including the light source is formed on the silicon wafer. The light beam detector may be achieved by a silicon structure or a III-V structure. In another embodiment, the light source, the light beam detector and the integrated circuit module 4 are all manufactured using III-V technology. The optoelectronic module 3 and the integrated circuit module 4 are formed on a same chip, so that connection wires thereof will be less, thus crosstalk noise between the wires and electrical contact resistances will be reduced, and an impedance thereof will be easily controlled, thereby significantly achieving better integration and miniaturized optical microphone package while reducing the dimensions of the optical microphone, and easing the package manufacturing of the optical microphone.

Each of the flexible film and the grating is provided with a respective reflective layer at a side facing the light source. The two reflective layers may be formed by a same material or be formed by different materials. The reflectivity is defined according to a wavelength of the light beam, and the material selection should make the reflectivity of the light beam maximized.

A part of the light emitted from the light source is diffracted by the grating and then is directed to the flexible film, and then is reflected by the flexible film to the light beam detector; and another part of the light emitted from the light source is reflected to the light beam detector by the reflective layer of the grating.

When the optical microphone is in use, sound waves enter the case 1 through the sound inlet aperture to actuate vibrations of the flexible film, thereby changing a distance between the flexible film and the grating. When the flexible film vibrates, the flexible film moves upward (or downward, depending on the type of microphone) and downward (or upward, depending on the type of microphone) in opposite directions, just like a standard oscillating structure, with a specific frequency and displacement. The frequency depends on the frequency of the sound wave, and the displacement depends on the pressure of the sound wave.

The light source emits a light beam, which is referred to as an incident light beam A directing to a center of the corresponding side of the grating and a center of the corresponding side of the flexible film, and the light beam reflected to the light beam detector is referred to as a reflected light beam B. Since the grating is arranged between the light source and the flexible film, the incident light beam A will reach the grating before reaching the flexible film.

A surface of the grating facing the light source is highly reflective, so that the incident light beam A is highly reflected to the light beam detector. A part of the light is diffracted after passing through the grating and then reaches the reflective surface of the flexible film. The light reflected by the flexible film is then directed to the light beam detector. Obviously, these two parts of reflected light beam B have a certain amplitude difference and phase difference when they reach the light beam detector, and the amplitude difference and phase difference are related to a distance between the flexible film and the grating. Thus, the micro-electromechanical module 2, the optoelectronic module 3 and the integrated circuit module 4 can achieve conversion from acoustic signal to optical signal and then to electrical signal.

In an example of this embodiment, the micro-electromechanical module 2 may further include a lens (not shown), which is arranged at a side of the grating facing the optoelectronic module 3 and is spaced from the grating. When the light emitted from the light source vertically irradiates the lens, the light will obliquely irradiate the grating after being refracted by the lens; and when the light reflected by the grating or the flexible film obliquely irradiates the lens, after being refracted by the lens, the light will vertically irradiate the light beam detector after being refracted by the lens.

In an example, a lens is arranged at a side of the grating facing the optoelectronic module 3, so that a path of the light emitted from the light source can be changed through refraction of the light by the lens. In this way, the lens may be useful to improve the position accuracy of the light beams, in the case of one single die.

In an example of this embodiment, the flexible film is further provided with a sound inlet hole that makes the front cavity communicate with the rear cavity. Specifically, the sound inlet hole can make the front cavity communicate with the rear cavity, so as to balance the sound pressure inside the front cavity and the rear cavity, thereby being more conductive to a beneficial effect of the flexible film vibrating under an action of the sound wave.

In an example of this embodiment, the grating includes a plurality of slits spaced from each other and arranged in parallel.

Specifically, the grating may be provided with a reflective planar layer. For example, the grating may use silicon as a base plate, and a metal film is provided on a side of the silicon facing the optoelectronic module 3 as a reflective layer by using a specific process. This metal can be gold, aluminum, silver or copper.

In an example of this embodiment, the grating is formed by a lens, and at least one diffractive layer is provided on the lens.

Specifically, the lens may use glass as a base plate, and a diffractive surface is formed by forming a regular non-flat surface (for example, a stepped surface) on the substrate, and diffraction of the light is achieved by a structure of the diffractive surface.

If the integrated circuit module 4 is also electrically connected to the flexible film and the grating, an electrostatic force is generated between the flexible film and the grating. For example, the integrated circuit module 4 is electrically connected to the flexible film and the grating, and an electrostatic force can be generated by applying a voltage between the flexible film and the grating by the integrated circuit module 4, so that an “electrostatic spring” is formed between the flexible film and the grating. When the flexible film is vibrated by the sound wave, the “electrostatic spring” provides an effect of “enlarging” or “reducing” deformation of the flexible film.

In an example of this embodiment, the optoelectronic module 3 may include a plurality of light beam detectors.

In an example of this embodiment, the flexible film has a shape that is symmetrical about its center. The shape of the flexible film is not limited to a circle shape, and may also be any shape that is symmetrical about its center, such as a square shape.

The flexible film may be formed by one material or more than one material, which may be monocrystalline silicon, silicon nitride, silicon oxide, polycrystalline silicon, polyimide, or a combination thereof

The structures, features, and effects of the present invention are described in details with reference to the above-described embodiments shown in the accompanying drawing. It should be noted that, the embodiments described above are merely preferred embodiments of the present invention, which do not constitute a limitation on the present invention, and any amendment or modification made in accordance with a concept of the present invention and equivalent embodiments thereof shall fall into a scope of the present invention.

What is claimed is:

1. An optical microphone, comprising:
a case comprising an inner cavity and a sound inlet aperture that makes the inner cavity communicate with an exterior;
a micro-electromechanical module provided in the inner cavity and comprising a flexible film and a grating, wherein the flexible film separates, along an incident direction of a sound wave, the inner cavity into a front cavity and a rear cavity, the front cavity covers the sound inlet aperture, and the grating is arranged at a side of the flexible film close to the rear cavity and is spaced from the flexible film;
an optoelectronic module provided in the rear cavity and comprising a light source and a light beam detector; and
an integrated circuit module provided in the rear cavity and electrically connected to the micro-electromechanical module and the optoelectronic module;
wherein the optoelectronic module and the integrated circuit module are provided on a same chip;
a reflective layer is provided at a side of the flexible film facing the light source, and another reflective layer is provided at a side of the grating facing the light source; and
a part of light emitted from the light source is diffracted by the grating, and then is directed to the flexible film, and then is reflected by the flexible film to the light beam detector; and another part of the light emitted from the light source is directly reflected by the grating reflective layer to the light beam detector.

2. The optical microphone as described in claim 1, wherein the micro-electromechanical module further comprises a lens, which is provided at a side of the grating facing the optoelectronic module and is spaced from the grating;
when the light emitted from the light source vertically irradiates the lens, the light obliquely irradiates the grating after being refracted by the lens; and
when light reflected by the grating or the flexible film obliquely irradiates the lens, the light vertically irradiates the light beam detector after being refracted by the lens.

3. The optical microphone as described in claim 1, wherein the flexible film is further provided with a sound inlet hole that makes the front cavity communicate with the rear cavity.

4. The optical microphone as described in claim 1, wherein the grating comprises a plurality of slits spaced from each other and arranged in parallel.

5. The optical microphone as described in claim 1, wherein the grating is formed by a lens, and the lens is provided with at least one diffractive surface.

6. The optical microphone as described in claim 1, wherein the optoelectronic module comprises a plurality of light beam detectors.

7. The optical microphone as described in claim 1, wherein the case is formed by a PCB board.

8. The optical microphone as described in claim 1, wherein the flexible film has a shape that is symmetrical about its center.

9. The optical microphone as described in claim 1, wherein the integrated circuit module is electrically connected to the flexible film and the grating, respectively.

10. The optical microphone as described in claim 1, wherein the micro-electromechanical module further comprises a supporting part that supports the flexible film and is fixed to the case; and the grating is arranged at a side of the flexible film facing away from the sound inlet aperture by a space, and the grating is spaced from the flexible film.
